(19) United States
(12) Patent Application Publication
(10) Pub. No.: US 2026/0360687 A1
(43) Pub. Date: Nov. 12, 2026

(54) METHOD FOR MANUFACTURING LITHIUM SECONDARY BATTERY ELECTRODE AND METHOD FOR MANUFACTURING SECONDARY BATTERY INCLUDING LITHIUM SECONDARY BATTERY ELECTRODE

(71) Applicant: SK ON CO., LTD., Seoul (KR)

(72) Inventors: Chang Mook HWANG, Daejeon (KR); Hyun Ji KIM, Daejeon (KR); Jong Hyeok LEE, Daejeon (KR); Yoon Ji JO, Daejeon (KR)

(21) Appl. No.: 19/477,110

(22) PCT Filed: Apr. 19, 2024
(86) PCT No.: PCT/KR2024/005279

§ 371 Date: Oct. 21, 2025

(30) Foreign Application Priority Data
Apr. 21, 2023 (KR) 10-2023-0052596

(51) Int. Cl. H01M 4/04; B60L 50/64; H01M 10/0587

(52) U.S. Cl. CPC H01M 4/0404; H01M 10/0587; B60L 50/64

(57) ABSTRACT

In a method for manufacturing an electrode for a secondary battery according to some embodiments, a first active material slurry is applied to an electrode current collector to form a first coating layer. The first coating layer is pre-dried to form a first preliminary active material layer. A second active material slurry is applied to the first preliminary active material layer to form a second coating layer. The first preliminary active material layer and the second coating layer are converted into a first active material layer and a second active material layer, respectively, through bulk drying performed at a temperature greater than the pre-drying temperature. Accordingly, the cycle life properties of an electrode including an active material layer having a multi-layer structure may be improved, and the resistance may be reduced.

### TECHNICAL FIELD

The present disclosure relates to a method for manufacturing an electrode for a secondary battery and a method for manufacturing a secondary battery including the electrode for a secondary battery. More specifically, the present disclosure relates to a method for manufacturing an electrode for a secondary battery including an active material layer having a multi-layer structure and a method for manufacturing a secondary battery including the electrode for a secondary battery.

### BACKGROUND ART

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric cars.

Examples of the secondary battery may include a lithium secondary battery, a nickel-cadmium battery, and a nickel-hydrogen battery. Among these, lithium secondary batteries are actively being researched and developed due to their high operating voltage, high energy density per unit weight, and advantages in charging speed and weight reduction.

For example, the lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are accommodated.

The electrode may include, for example, an active material layer having a multi-layer structure. However, a secondary battery including such an active material layer having a multi-layer structure may experience increased resistance and degraded cycle life properties due to natural mixing between the active material layers.

### SUMMARY OF INVENTION

### Problems to be Solved by Invention

An object of the present disclosure is to provide a method for manufacturing an electrode for a secondary battery with improved cycle life properties.

Another object of the present disclosure is to provide a secondary battery including the electrode for a secondary battery.

### Means for Solving Problems

In a method for manufacturing an electrode for a secondary battery according to some embodiments, a first active material slurry may be applied to an electrode current collector to form a first coating layer. The first coating layer may be pre-dried to form a first preliminary active material layer. A second active material slurry may be applied to the first preliminary active material layer to form a second coating layer. The first preliminary active material layer and the second coating layer may be converted into a first active material layer and a second active material layer, respectively, through bulk drying performed at a temperature greater than the pre-drying temperature.

In some embodiments, the pre-drying may include exposing the first coating layer to warm air at 40 to 60 °C.

In some embodiments, the pre-drying may include exposing an upper surface of the first coating layer to warm air for 5 to 20 seconds per cm².

In some embodiments, the first active material slurry may be supplied onto the electrode current collector through a first coating unit, and the second active material slurry may be supplied onto the first preliminary active material layer through a second coating unit, and the second coating unit may be spaced apart from the first coating unit along a coating direction.

In some embodiments, the pre-drying may be performed through a first drying unit, the bulk drying may be performed through a second drying unit, and the first drying unit may be disposed between the first coating unit and the second coating unit along the coating direction.

In some embodiments, the second coating unit may be disposed between the first drying unit and the second drying unit along the coating direction.

In some embodiments, the first active material slurry may include a first active material and a first solvent, and the second active material slurry may include a second solvent that is immiscible with the first solvent.

In some embodiments, the density of the first solvent may be greater than the density of the second solvent.

In some embodiments, the first active material and the second active material may be the same active material.

In some embodiments, the amount of the first active material included in the first active material layer may be different from the amount of the second active material included in the second active material layer.

In a method for manufacturing a secondary battery according to some embodiments, the electrode for a secondary battery manufactured according to the method for manufacturing an electrode for a secondary battery may be prepared. The electrode for a secondary battery may be wound to form an electrode assembly. The electrode assembly may be accommodated in a case.

In some embodiments, the density of the active material layer disposed on the inner side in the winding direction of the electrode for a secondary battery may be lower than the density of the active material layer disposed on the outer side.

In some embodiments, the step of forming the electrode assembly may include: arranging the electrodes for a secondary battery on a first surface and a second surface opposite to each other of a separation membrane, respectively; and winding the separation membrane together with the electrodes for a secondary battery.

### Advantageous Effects

According to some embodiments, the active material layer of the electrode may include a multi-layer structure. Forming the active material layer having a multi-layer structure may include pre-drying a first coating layer formed on the electrode current collector. Accordingly, when forming a second coating layer on the first preliminary active material layer formed by pre-drying the first coating layer, appropriate natural mixing may be induced. Therefore, cohesion between the active material layers may be improved. In addition, the resistance of the electrode may be reduced, and cycle performance relative to the same capacity may be improved.

In some embodiments, the solvents included in the slurries for forming the active material layer having a multi-layer structure may be different. Accordingly, excessive mixing between the active material layers having a multi-layer structure may be suppressed, thereby reducing the resistance of the secondary battery and improving cycle performance.

According to some embodiments, the density of the active material layer disposed on the inner side during the winding operation may be relatively reduced compared to the density of the active material layer disposed on the outer side during the winding operation. Accordingly, the densities of the active material layers disposed on the outer and inner sides of the winding may be substantially uniformly controlled. As a result, electrode cracks and delamination due to variations in the distribution of the active material within the jelly-roll may be prevented, thereby achieving uniform energy density and cycle life properties.

The method for manufacturing an electrode for a secondary battery of the present disclosure and the secondary battery manufactured according to the method may be widely applied in green technology fields, such as electric vehicles, battery charging stations, as well as solar power generation, wind power generation, and the like, which use the batteries. The anode active material for a lithium secondary battery of the present disclosure, the method for manufacturing the same, and the lithium secondary battery including the same may be used in eco-friendly electric vehicles, hybrid vehicles, and the like, which are aimed at mitigating climate change by reducing air pollution and greenhouse gas emissions.

### BRIEF DESCRIPTION OF DRAWINGS

FIGS. 1 to 3 are cross-sectional views for describing a method for manufacturing an electrode for a secondary battery according to some embodiments.

FIGS. 4 and 7 are views for describing a method for manufacturing a secondary battery according to some embodiments.

### MODE FOR CARRYING OUT INVENTION

Embodiments of the present disclosure provide a method for manufacturing an electrode including an active material layer having a multi-layer structure. In addition, a method for manufacturing a secondary battery including the electrode for a secondary battery is provided.

Hereinafter, the embodiments of the present disclosure will be described in more detail with reference to the accompanying drawings. However, the drawings attached to the present disclosure are merely illustrative of some embodiments of the present disclosure to aid in understanding the technical spirit of the invention together with the foregoing description. Therefore, the present disclosure should not be construed as being limited to the matters illustrated in the drawings.

As used herein, the terms “upper portion,” “lower portion,” “upper surface,” “lower surface,” and the like, are used in a relative sense to distinguish the positions of components, and do not specify absolute positions.

FIGS. 1 to 3 are cross-sectional views for describing a method for manufacturing an electrode for a secondary battery according to some embodiments.

For convenience of description, FIGS. 1 to 3 illustrate a first coating layer 70, a first preliminary active material layer 73, and a second coating layer 80 formed on only one surface of an electrode current collector 60, but they may be formed on both surfaces of the electrode current collector 60.

Referring to FIG. 1, the electrode current collector 60 may be supplied through a supply roll 50. For example, the electrode current collector 60 may be continuously supplied while the supply roll 50 rotates in a horizontal direction. The horizontal direction may be, for example, the direction indicated by an arrow in the drawings.

According to some embodiments, a first active material slurry may be applied to the electrode current collector 60 to form a first coating layer. For example, the first active material slurry may be prepared by mixing the first active material with a binder, a conductive material and/or a dispersant in a first solvent.

In some embodiments, the first active material slurry may be applied to the electrode current collector 60 by a first coating unit 53 to form the first coating layer 70. The first coating unit 53 may be, for example, a coater including a slot die.

In an embodiment, the first active material slurry may be introduced into the first coating unit 53 through one end portion (e.g., a slot die), and the first active material slurry may be discharged from the other end portion (e.g., a slot die head). Accordingly, the first active material slurry may be applied to the electrode current collector 60.

In an embodiment, the electrode current collector 60 may move in the horizontal direction (e.g., in the direction indicated by the arrow) so that the first coating layer 70 may be formed on the electrode current collector 60 through the first coating unit 53. The horizontal direction may be the same direction as the movement direction of the electrode current collector 60 driven by the supply roll 50. Accordingly, the first coating unit 53 may continuously form the first coating layer 70 on the electrode current collector 60 without moving itself.

According to some embodiments, the first preliminary active material layer 73 may be formed by pre-drying the first coating layer 70. For example, a portion of the first solvent of the first coating layer 70 may be evaporated to form the first preliminary active material layer 73.

In some embodiments, the first coating layer 70 may be exposed to warm air. Accordingly, the first coating layer 70 may be pre-dried.

The warm air may be, for example, 30 to 70 °C, and preferably 40 to 60 °C. Within this range, the first coating layer 70 may be pre-dried without being excessively dried. Accordingly, the first preliminary active material layer 73 may undergo constant natural mixing with the second coating layer 80 described below, thereby improving the cohesion between the first active material layer 75 and the second active material layer 85.

The first coating layer 70 may be exposed to the warm air for, for example, 3 to 30 seconds, preferably 5 to 20 seconds, per cm² of an upper surface of the first coating layer 70. Within this range, the first coating layer 70 may be sufficiently pre-dried. Accordingly, excessive natural mixing between the first preliminary active material layer 73 and the second coating layer 80 may be suppressed, thereby reducing the resistance of the secondary battery and improving the capacity retention.

In some embodiments, the pre-drying process may be performed through a first drying unit 55. The first drying unit 55 may be a dryer capable of supplying warm air. For example, the first drying unit 55 may be, for example, a warm air heater, a heat pump hot air dryer, an electric hot air dryer or the like.

In an embodiment, when the electrode current collector 60 with the first coating layer 70 formed thereon enters the first drying unit 55, the movement of the electrode current collector 60 with the first coating layer 70 formed thereon may be stopped for a predetermined period of time. For example, the supply of the electrode current collector 60 from the supply roll 50 may be stopped for the predetermined period of time.

The predetermined period of time may be, for example, 5 to 30 seconds, or 10 to 20 seconds. Accordingly, the degree of drying of the first preliminary active material layer 73 may be controlled. As a result, the cohesion between the first active material layer 75 and the second active material layer 85 may be improved while suppressing excessive natural mixing with the second coating layer 80.

In an embodiment, the electrode current collector 60 with the first coating layer 70 formed thereon may be pre-dried by the first drying unit 55 while moving in the horizontal direction (e.g., in the direction indicated by the arrow). The horizontal direction may be the same direction as the direction in which the first coating layer 70 is formed. Accordingly, the first coating layer 70 may be continuously pre-dried without movement of the first drying unit 55, thereby forming the first preliminary active material layer 73.

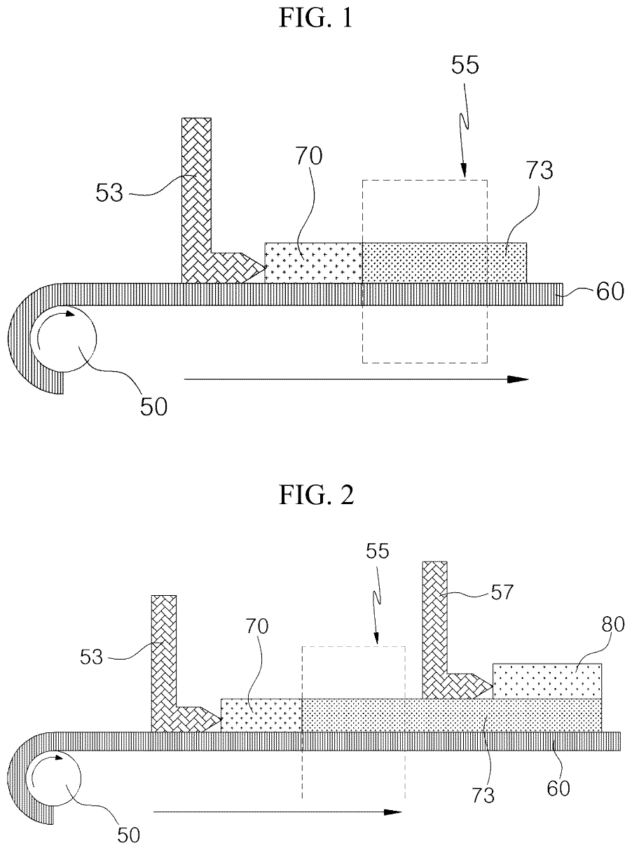

Referring to FIG. 2, a second active material slurry may be applied to the first preliminary active material layer 73 to form a second coating layer. For example, the second active material slurry may be prepared by mixing the second active material with a binder, a conductive material and/or a dispersant in a second solvent.

The first solvent for forming the first active material slurry and the second solvent for forming the second active material slurry may be, for example, a polar aprotic solvent, a polar protic solvent, or a non-polar solvent.

The polar aprotic solvent may include, for example, N-methyl-2-pyrrolidone (NMP), dimethylformamide (DMF), dimethyl sulfoxide (DMSO), acetonitrile, butylene carbonate, propylene carbonate (PC), dimethyl carbonate (DMC), diethyl carbonate (DEC), ethyl methyl carbonate (EMC), methyl propyl carbonate (MPC), ethylene carbonate (EC), ethyl bromide, tetrahydrofuran (THf), acetone or the like.

The polar protic solvent may include, for example, deionized water, distilled water, ethanol, isopropanol, methanol, n-propanol, t-butanol or the like.

The non-polar solvent may include, for example, hexane, heptane, carbon tetrachloride, benzene, toluene, ethylbenzene, xylene, 1,4-dioxane or the like. These may be used alone or in combination of two or more thereof.

In some embodiments, the first solvent and the second solvent may be different solvents.

In an embodiment, the first solvent may be a solvent having a higher density than the second solvent. In another embodiment, the first solvent may be a solvent having a polarity different from that of the second solvent, and accordingly, the second solvent may be immiscible with the first solvent. Accordingly, excessive stirring between the first preliminary active material layer 73 and the second coating layer 80 may be suppressed.

In some embodiments, the first active material and the second active material may be the same active material. Accordingly, even if an active material layer having a multi-layer structure is formed, the resistance between the active material layers due to a difference in active materials may be reduced.

According to some embodiments, the electrode current collector 60 with the first preliminary active material layer 73 formed thereon may move in the direction indicated by the arrow while the second active material slurry is applied to the first preliminary active material layer 73, thereby forming the second coating layer 80.

In some embodiments, the second active material slurry may be applied to the first preliminary active material layer 73 by a second coating unit 57 to form the second coating layer 80. The second coating unit 57 may be, for example, a coater including a slot die.

In an embodiment, the second active material slurry may be introduced into the second coating unit 57 through one end portion (e.g., a slot die), and the second active material slurry may be discharged from the other end portion (e.g., a slot die head). Accordingly, the second active material slurry may be applied to the first preliminary active material layer 73.

In some embodiments, the second coating layer 80 may be formed to entirely cover the first preliminary active material layer 73. Accordingly, the migration of lithium ions between the first active material layer 75 and the second active material layer 85 may be maintained without interruption, thereby inhibiting an increase in resistance.

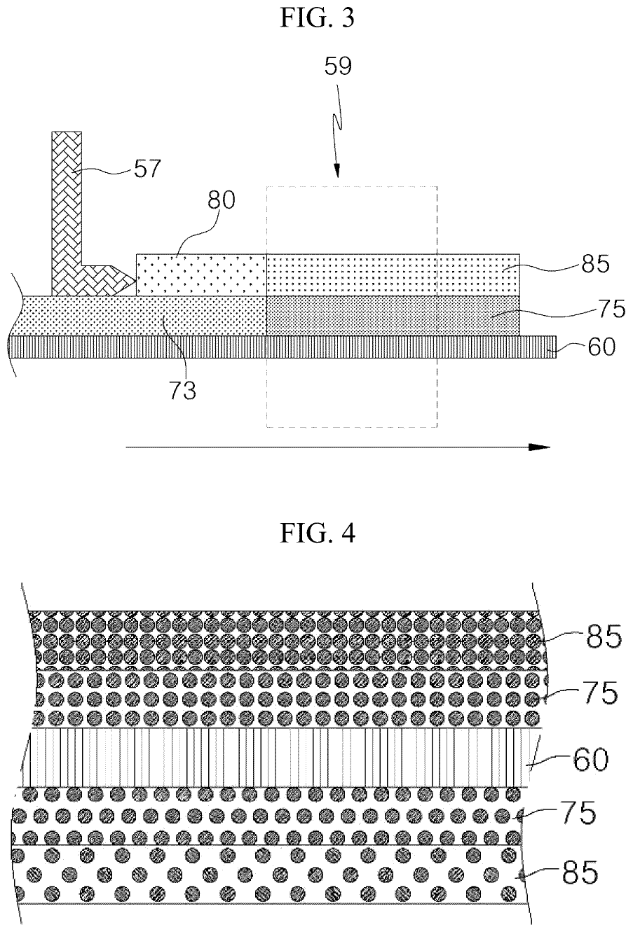

Referring to FIG. 3, the first preliminary active material layer 73 and the second coating layer 80 may be dried simultaneously.

According to some embodiments, the first preliminary active material layer 73 and the second coating layer 80 may be bulk-dried to be converted into the first active material layer 75 and the second active material layer 85, respectively. For example, the first solvent and the second solvent of the first preliminary active material layer 73 and the second coating layer 80 may be evaporated to be converted into the first active material layer 75 and the second active material layer 85, respectively.

In some embodiments, the bulk drying may be performed at a higher temperature than the pre-drying.

The bulk drying may be performed, for example, at a temperature of 100 to 120 °C, or 105 to 115 °C, for 60 to 120 seconds, or 80 to 100 seconds. Within this range, the first preliminary active material layer 73 and the second coating layer 80 may be completely dried, and additional natural mixing between the formed first active material layer 75 and the second active material layer 85 may be suppressed.

In some embodiments, the bulk drying may be performed through a second drying unit 59. The second drying unit 59 may be, for example, a hot air heater, a heat pump hot air dryer, an electric hot air dryer or the like.

In some embodiments, the first coating unit 53 may be formed at a predetermined distance from the second coating unit 57. In addition, the first drying unit 55 may be formed at a predetermined distance from the second drying unit 59.

In this case, the first drying unit 55 may be disposed between the first coating unit 53 and the second coating unit 57. Further, the second coating unit 57 may be disposed between the first drying unit 55 and the second drying unit 59. Accordingly, the formation of the above-described coating layers, pre-drying, and bulk drying may be performed continuously in a single process.

According to some embodiments, the first active material layer 75 and the second active material layer 85 may be formed on the upper surface and the lower surface of the electrode current collector 60, respectively.

For example, the active material layers 75 and 85 may be formed on the upper surface of the electrode current collector 60 and then on the lower surface of the electrode current collector 60. Alternatively, the active material layers 75 and 85 may be formed simultaneously on the upper surface and the lower surface of the electrode current collector 60.

In this case, the method for forming the active material layers 75 and 85 on the lower surface of the electrode current collector 60 may be substantially the same as or similar to the method for forming the active material layers 75 and 85 on the upper surface of the electrode current collector 60.

Therefore, an electrode having a multi-layer structure including a first active material layer 75 and a second active material layer 85 formed on both surfaces of the electrode current collector 60 may be formed.

The electrode for a secondary battery manufactured as described above may be provided as a cathode 90 for a secondary battery or an anode 110 for a secondary battery.

In some embodiments, the electrode may be an electrode for a cathode. In this case, the active material included in the cathode active material layer 100 of the cathode 90 may include a compound capable of reversibly intercalating and deintercalating lithium ions. The active material may include lithium-transition metal composite oxide particles. For example, the lithium-transition metal composite oxide particles may include nickel (Ni), and may further include at least one of cobalt (Co) or manganese (Mn).

For example, the lithium-transition metal composite oxide particle may be represented by Formula 1 below.

LiₓNi_{1-y}M_{y}O_{2+z} [Formula 1]

In Formula 1, x may be in the range of 0.9≤x≤1.1, y may be in the range of 0≤y≤0.7, and z may be in the range of −0.1≤z≤0.1. M may represent one or more elements selected from Na, Mg, Ca, Y, Ti, Zr, Hf, V, Nb, Ta, Cr, Mo, W, Mn, Co, Fe, Cu, Ag, Zn, B, Al, Ga, C, Si, Sn and Sr.

A cathode binder may include, for example, an organic binder such as vinylidene fluoride-hexafluoropropylene copolymer (PVDF-co-HFP), polyvinylidene fluoride (PVDF), polyacrylonitrile, polymethyl methacrylate, and the like, or an aqueous binder such as styrene-butadiene rubber (SBR). The cathode binder may be included together with a thickener such as carboxymethyl cellulose (CMC).

For example, a PVDF-based binder may be used as the cathode binder. In this case, the amount of the binder for forming the cathode active material layer may be reduced and the amount of the cathode active material may be relatively increased, thereby improving the output and capacity of the secondary battery.

The cathode current collector 95 may include, for example, stainless steel, nickel, aluminum, titanium, copper, or an alloy thereof. For example, the cathode current collector 95 may include aluminum or an aluminum alloy.

A cathode conductive material may be included to promote electron migration between the active material particles. For example, the cathode conductive material may include carbon-based conductive materials such as graphite, carbon black, graphene, or carbon nanotubes, and/or metal-based conductive materials, including perovskite materials, such as tin, tin oxide, titanium oxide, LaSrCoO₃, and LaSrMnO₃, and the like.

In some embodiments, the electrode may be an electrode for an anode. In this case, the active material included in the anode active material layer 120 of the anode 110 may include a compound capable of adsorbing and desorbing lithium ions. For example, the active material may include carbon-based materials such as crystalline carbon, amorphous carbon, carbon composites, and carbon fibers, a lithium alloy, a silicon (Si)-based compound, or tin.

The amorphous carbon may include, for example, hard carbon, coke, or mesophase pitch-based carbon fiber (MPCF). The crystalline carbon may include, for example, graphitic carbon such as natural graphite, artificial graphite, coke, or graphitized MCMB. The elements included in the lithium alloy may include, for example, aluminum, zinc, bismuth, cadmium, antimony, silicon, lead, tin, gallium, indium or the like. The silicon-based compound may include, for example, a silicon-carbon composite oxide, such as silicon oxide (SiOₓ) or silicon carbide (SiC).

An anode binder may include, for example, an aqueous binder such as styrene-butadiene rubber (SBR) to ensure compatibility with a carbon-based active material. The anode binder may be included together with a thickener such as carboxymethyl cellulose (CMC).

The anode current collector 115 may include gold, stainless steel, nickel, aluminum, titanium, copper, or an alloy thereof. For example, the anode current collector 115 may include copper or a copper alloy.

The anode conductive material may include, for example, a carbon-based conductive material such as carbon nanotubes, carbon black, or Super P.

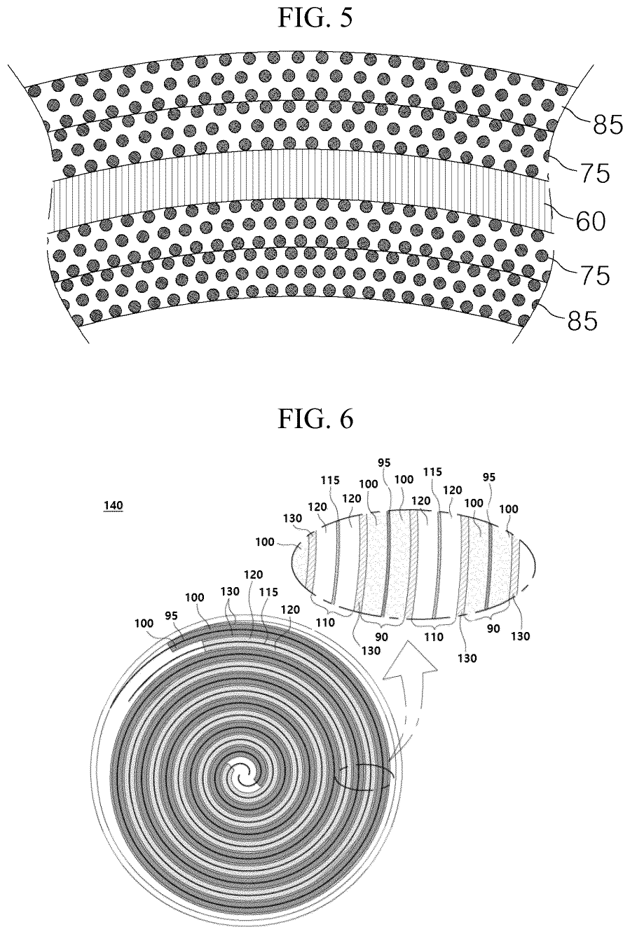

FIGS. 4 to 7 are views for describing a method for manufacturing a secondary battery according to some embodiments.

Referring to FIG. 4, the electrode for a secondary battery manufactured as described with reference to FIGS. 1 to 3 may be prepared. The electrode for a secondary battery may have the active material layers 75 and 85 formed on both surfaces of the electrode current collector 60. For example, the active material may be dispersed in the form of particles within the active material layers 75 and 85, as indicated by the black dots in FIG. 4.

According to some embodiments, the amount of the first active material included in the first active material layer 75 and the amount of the second active material included in the second active material layer 85 may be different from each other. Accordingly, an electrode may be formed in which the densities of the first active material layer 75 and the second active material layer 85 formed on upper and lower surfaces of the electrode current collector 60 are different from each other. For example, as described below, when the electrode is wound, the amounts of the first active material included in the first active material layer 75 and the second active material included in the second active material layer 85 may be adjusted such that the density of the active material layer disposed on the inner side in the winding direction may be lower than that of the active material layer disposed on the outer side.

In some embodiments, the electrode may be wound with the second active material layer 85 formed on the lower surface of the electrode current collector 60 disposed on an inner side of the winding. In this case, the average density of the active material layers 75 and 85 formed on the upper surface of the electrode current collector 60 may be greater than the average density of the active material layers 75 and 85 formed on the lower surface of the electrode current collector 60.

In an embodiment, the amount of the first active material included in the first active material layer 75 formed on the upper surface of the electrode current collector 60 may be lower than the amount of the second active material included in the second active material layer 85 formed on the first active material layer 75. Accordingly, the density of the first active material layer 75 formed on the upper surface of the electrode current collector 60 may be lower than that of the second active material layer 85 formed on the first active material layer 75.

In an embodiment, the amount of the first active material included in the first active material layer 75 formed on the lower surface of the electrode current collector 60 may be greater than the amount of the second active material included in the second active material layer 85 formed on the first active material layer 75. Accordingly, the density of the first active material layer 75 formed on the lower surface of the electrode current collector 60 may be greater than that of the second active material layer 85 formed on the first active material layer 75.

In some embodiments, the electrode may be wound with the second active material layer 85 formed on the upper surface of the electrode current collector 60 disposed on the inner side of the winding. In this case, the average density of the active material layers 75 and 85 formed on the upper surface of the electrode current collector 60 may be lower than the average density of the active material layers 75 and 85 formed on the lower surface of the electrode current collector 60.

In an embodiment, the amount of the first active material included in the first active material layer 75 formed on the upper surface of the electrode current collector 60 may be greater than the amount of the second active material included in the second active material layer 85 formed on the first active material layer 75. Accordingly, the density of the first active material layer 75 formed on the upper surface of the electrode current collector 60 may be greater than that of the second active material layer 85 formed on the first active material layer 75.

In an embodiment, the amount of the first active material included in the first active material layer 75 formed on the lower surface of the electrode current collector 60 may be lower than the amount of the second active material included in the second active material layer 85 formed on the first active material layer 75. Accordingly, the density of the first active material layer 75 formed on the lower surface of the electrode current collector 60 may be lower than that of the second active material layer 85 formed on the first active material layer 75.

Referring to FIG. 5, a wound electrode may be formed by winding an electrode including the first active material layers 75 and the second active material layers 85 having different densities formed on the upper and lower surfaces of the electrode current collector 60, respectively.

In some embodiments, the electrode may be wound with the second active material layer 85 formed on the upper surface of the electrode current collector 60 disposed on an outer side of the winding. Alternatively, a wound electrode may be formed by winding the electrode into a jelly-roll shape with the second active material layer 85 formed on the lower surface of the electrode current collector 60 disposed on the inner side of the winding. Accordingly, an upper wound active material layer and a lower wound active material layer may be formed.

In an embodiment, the upper wound active material layer, including the active material layers 75 and 85 formed on the upper surface of the electrode current collector 60, may have a relatively high density. The upper wound active material layer may be stretched under winding tension. Accordingly, the active material density may decrease as a tensile force is applied to the upper wound active material layer having the relatively high density.

In an embodiment, the lower wound active material layer, including the active material layers 75 and 85 formed on the lower surface of the electrode current collector 60, may have a relatively low density. The lower wound active material layer may be compressed under winding compression. Accordingly, the density of the active material may increase as a compressive force is applied to the lower wound active material layer having the relatively low density.

In some embodiments, the electrode may be wound with the second active material layer 85 formed on the upper surface of the electrode current collector 60 disposed on the inner side of the winding. Alternatively, a wound electrode may be formed by winding the electrode into a jelly-roll shape with the second active material layer 85 formed on the lower surface of the electrode current collector 60 disposed on the outer side of the winding. Accordingly, an upper wound active material layer and a lower wound active material layer may be formed.

In an embodiment, the lower wound active material layer, including the active material layers 75 and 85 formed on the lower surface of the electrode current collector 60, may have a relatively high density. The lower wound active material layer may be stretched under winding tension. Accordingly, the active material density may decrease as a tensile force is applied to the lower wound active material layer having the relatively high density.

In an embodiment, the upper wound active material layer, including the active material layers 75 and 85 formed on the upper surface of the electrode current collector 60, may have a relatively low density. The lower wound active material layer may be compressed under winding compression. Accordingly, the density of the active material may increase as a compressive force is applied to the upper wound active material layer having the relatively low density.

As described above, the density of the upper wound active material layer may decrease and the density of the lower wound active material layer may increase. Accordingly, the densities of the upper wound active material layer and the lower wound active material layer of the wound electrode may be substantially uniform overall.

Referring to FIG. 6, the electrodes described with reference to FIGS. 4 and 5 may be disposed on a first surface and a second surface opposite to each other of a separation membrane, respectively, and a separation membrane 130 may be wound together with the electrodes.

For convenience of description, FIG. 6 illustrates that the active material layer is formed as a single layer on both surfaces of the electrode current collector 60; however, the active material layer may be an active material layer having a multi-layer structure including the first active material layer 75 and the second active material layer 85.

According to some embodiments, the separation membrane 130 may be disposed between the cathode 90 and the anode 110, and the cathode 90 and the anode 110 may be wound together using the separation membrane 130. Accordingly, a wound-shaped electrode assembly 140 may be manufactured.

The cathode 90 may include a cathode current collector 95 and a cathode active material layer 100 with the cathode current collector 95 interposed therebetween.

For example, the density of the cathode active material layer 100 disposed on the lower surface of the cathode current collector 95 may be relatively low. In this case, the cathode active material layer 100 disposed on the lower surface of the cathode current collector 95 may be located on the inner side of the winding, and the cathode active material layer 100 disposed on the upper surface of the cathode current collector 95 may be located on the outer side of the winding.

For example, the density of the cathode active material layer 100 disposed on the upper surface of the cathode current collector 95 may be relatively low. In this case, the cathode active material layer 100 disposed on the upper surface of the cathode current collector 95 may be located on the inner side of the winding, and the cathode active material layer 100 disposed on the lower surface of the cathode current collector 95 may be located on the outer side of the winding.

Accordingly, the densities of the cathode active material layers 100 disposed on both surfaces of the cathode current collector 95 may be substantially the same.

The anode 110 may include an anode current collector 115 and anode active material layers 120 with the anode current collector 115 interposed therebetween.

For example, the density of the anode active material layer 120 disposed on the lower surface of the anode current collector 115 may be relatively low. In this case, the anode active material layer 120 disposed on the lower surface of the anode current collector 115 may be located on the inner side of the winding, and the anode active material layer 120 disposed on the upper surface of the anode current collector 115 may be located on the outer side of the winding.

For example, the density of the anode active material layer 120 disposed on the upper surface of the anode current collector 115 may be relatively low. In this case, the anode active material layer 120 disposed on the upper surface of the anode current collector 115 may be located on the inner side of the winding, and the anode active material layer 120 disposed on the lower surface of the anode current collector 115 may be located on the outer side of the winding.

Accordingly, the densities of the anode active material layers 120 disposed on both surfaces of the anode current collector 115 may be substantially the same.

The separation membrane 130 may include a porous polymer film made of a polyolefin polymer such as an ethylene homopolymer, propylene homopolymer, ethylene/butene copolymer, ethylene/hexene copolymer, ethylene/methacrylate copolymer. The separation membrane 130 may include a nonwoven fabric made of glass fibers having a high melting point, polyethylene terephthalate fibers, and the like.

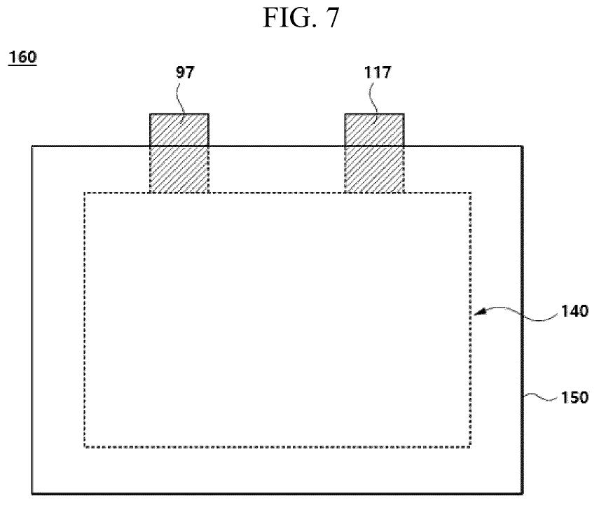

Referring to FIG. 7, a secondary battery 160 may be manufactured by preparing the electrode assembly 140 as described with reference to FIG. 6 and accommodating the electrode assembly 140 within a case 150.

The electrode assembly 140 may be accommodated in the outer case 150 together with an electrolyte, thereby defining the secondary battery 160. According to some embodiments, a non-aqueous electrolyte may be used as the electrolyte.

The non-aqueous electrolyte may include a lithium salt of an electrolyte and an organic solvent. The lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, and the like may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethylsulfuroxide, acetonitrile, dimethoxyethane, diethoxyethane, vinylene carbonate, sulfolane, gamma-butyrolactone, propylene sulfite and tetrahydrofuran, and the like may be used. These may be used alone or in combination of two or more thereof.

As shown in FIG. 7, electrode tabs may protrude from the electrode current collectors, which belong to each electrode cell, and may extend to one side of the outer case 150. The electrode tabs may be fused together with the one side of the outer case 150 and connected to electrode leads 97 and 117 that extend or are exposed to the outside of the outer case 150.

The lithium secondary battery 160 may be manufactured, for example, in a cylindrical shape using a can, a prismatic shape, a pouch shape or a coin shape.

Hereinafter, experimental examples including specific examples and comparative examples are presented to aid in the understanding of the present invention. However, these examples are provided merely for illustrative purposes of the present invention and are not intended to limit the scope of the appended claims. It will be apparent to those skilled in the art that various changes and modifications may be made within the scope and spirit thereof, and such changes and modifications are to be regarded as falling within the scope of the appended claims.

### Examples and Comparative Examples

### Example 1

### 1) Preparation of Anode

A first anode slurry was prepared by mixing 24 wt % of natural graphite, 70 wt % of artificial graphite, 1 wt % of carboxymethyl cellulose (CMC), 4 wt % of styrene-butadiene rubber, and 1 wt % of carbon nanotubes (CNTs) as a conductive material in a solvent. The first anode slurry was applied to a copper (Cu) foil current collector to form a first anode coating layer. The first anode coating layer was then pre-dried through a first drying unit to form a first preliminary anode active material layer. Propylene carbonate (PC) was used as the solvent.

The first drying unit supplied warm air at 45 °C to the first anode coating layer to pre-dry it. In addition, the first anode coating layer was exposed to the warm air for 10 seconds per cm² of the first anode coating layer.

A second anode slurry was prepared by mixing 24 wt % of natural graphite, 70 wt % of artificial graphite, 1 wt % of carboxymethyl cellulose (CMC), 4 wt % of styrene-butadiene rubber (SBR), and 1 wt % of carbon nanotubes (CNTs) as a conductive material in a solvent. The second anode slurry was applied to the first preliminary anode active material layer to form a second anode coating layer. The first preliminary anode active material layer and the second anode coating layer were then bulk-dried and roll-pressed together through a second drying unit to form the first anode active material layer and the second anode active material layer. Distilled water was used as the solvent.

### 2) Preparation of Cathode

A first cathode slurry was prepared by mixing LiNi_{0.8}Co_{0.1}Mn_{0.1}O₂ as a cathode active material, carbon black and carbon nanotubes (CNTs) as cathode conductive materials, and polyvinylidene fluoride (PVDF) as a cathode binder in a solvent at a weight ratio of 94:2:4. The first cathode slurry was applied to an aluminum (Al) foil current collector to form a first cathode coating layer. The first cathode coating layer was then pre-dried through a first drying unit to form a first preliminary cathode active material layer. Propylene carbonate (PC) was used as the solvent.

The first drying unit supplied warm air at 45 °C to the first cathode coating layer to pre-dry it. In addition, the first cathode coating layer was exposed to the warm air for 10 seconds per cm² of the first cathode coating layer.

A second cathode slurry was prepared by mixing LiNi_{0.8}Co_{0.1}Mn_{0.1}O₂ as a cathode active material, carbon black and carbon nanotubes (CNTs) as cathode conductive materials, and polyvinylidene fluoride (PVDF) as a cathode binder in a solvent at a weight ratio of 94:2:4. The second cathode slurry was applied to the first preliminary cathode active material layer to form a second cathode coating layer. The first preliminary cathode active material layer and the second cathode coating layer were then bulk-dried and roll-pressed together through a second drying unit to form the first cathode active material layer and the second cathode active material layer. Distilled water was used as the solvent.

### 3) Manufacture of Cell

A polyethylene (PE) separation membrane was interposed between the anode and the cathode. An electrolyte was then injected to manufacture a cell.

### Example 2

A cell was manufactured in the same manner as in Example 1, except that the first anode coating layer and the first cathode coating layer were each exposed to warm air supplied from the first drying unit for 5 seconds per cm² of the first anode coating layer and the first cathode coating layer.

### Example 3

A cell was manufactured in the same manner as in Example 1, except that the first anode coating layer and the first cathode coating layer were each exposed to warm air supplied from the first drying unit for 30 seconds per cm² of the first anode coating layer and the first cathode coating layer.

### Example 4

A cell was manufactured in the same manner as in Example 1, except that the warm air supplied to the first anode coating layer and the first cathode coating layer in the first drying unit was 60 °C.

### Example 5

A cell was manufactured in the same manner as in Example 2, except that the warm air supplied to the first anode coating layer and the first cathode coating layer in the first drying unit was 60 °C.

### Comparative Example 1

Propylene carbonate (PC) was used as the solvent for the first anode slurry, the second anode slurry, the first cathode slurry, and the second cathode slurry.

The first anode coating layer and the second anode coating layer were bulk-dried together without pre-drying the first anode coating layer.

In addition, the first cathode coating layer and the second cathode coating layer were bulk-dried together without pre-drying the first cathode coating layer.

A cell was manufactured in the same manner as in Example 1 except for the above-described procedures.

### Comparative Example 2

A cell was manufactured in the same manner as in Comparative Example 1, except that the solvent used in the first anode slurry and the first cathode slurry was propylene carbonate (PC), and the solvent used in the second anode slurry and the second cathode slurry was distilled water.

### Experimental Example

### (1) Bonding Strength Between the Anode Current Collector and the First Anode Active Material Layer

Double-sided tape was attached to a glass plate, and the anodes manufactured according to the examples and comparative examples were attached to the double-sided tape. A force was then applied until the anode active material layer was peeled from the anode current collector, and the bonding strength between the anode current collector and the first anode active material layer was measured.

### (2) Cohesion Between the First Anode Active Material Layer and the Second Anode Active Material Layer

A force was applied until the second anode active material layer was peeled from the first anode active material layer in the anodes manufactured according to the examples and comparative examples, and the cohesion between the first anode active material layer and the second anode active material layer was measured.

### (3) Evaluation of Resistance Performance

The average resistance of the secondary battery cells according to the examples and comparative examples was measured at 1C for 10 seconds when the state of charge (SOC) was set to 5000.

### (4) Evaluation of Cycle Performance

The battery cells according to the examples and comparative examples were subjected to repeated charging (CC-CV 1.0C 4.2V cut-off) and discharging (1.0C 2.7V cut-off), and the number of cycles until the first anode active material layer and the second anode active material layer were detached was measured.

The evaluation results are shown in Table 1 below.

TABLE 1

| | | First active | | | |
|---|---|---|---|---|---|
| | Current | material | | | |
| | collector- | layer - | | | |
| | active | second | | | |
| | material | active | | | Cell |
| | layer | material | | Cell | cycle |
| | bonding | layer | Cell | resistance | perfor- |
| | strength | cohesion | capacity | performance | mance |
| | (N) | (N) | (Ah) | (mΩ) | (cycles) |
| Example 1 | 40 | 25 | 50 | 0.95 | 2500 |
| Example 2 | 40 | 15 | 50 | 1.15 | 1500 |
| Example 3 | 30 | 20 | 50 | 1.1 | 1800 |
| Example 4 | 30 | 20 | 50 | 1.09 | 1900 |
| Example 5 | 40 | 20 | 50 | 1.0 | 2000 |
| Comparative | 30 | 20 | 50 | 1.0 | 2000 |
| Example 1 | | | | | |
| Comparative | 30 | 10 | 50 | 1.2 | 1000 |
| Example 2 | | | | | |

Referring to Table 1, in the examples where different solvents were used and pre-drying was performed, compared to Comparative Example 2 where different solvents were used but pre-drying was not performed, the bonding strength between the electrode current collector and the first anode active material layer, the cohesion between the first anode active material layer and the second anode active material layer, and the cell cycle performance were all improved, while the cell resistance was reduced.

In Example 1, where the first anode slurry was pre-dried at 45 °C for 10 seconds, the bonding strength between the anode current collector and the active material layer, the cohesion between the first anode active material layer and the second anode active material layer, and the cell cycle performance were improved, while the cell resistance was reduced, compared to Comparative Example 1 where a single solvent was used.

In Example 2, where the pre-drying time was reduced to 5 seconds, the bonding strength between the first anode active material layer and the second anode active material layer and the cell cycle performance decreased, and the cell resistance increased, compared to Example 1.

In Example 3, where the pre-drying time was increased to 30 seconds, the bonding strength between the anode current collector and the first anode active material layer, the cohesion between the first anode active material layer and the second anode active material layer, and the cell cycle performance decreased, while the cell resistance increased, compared to Example 1.

In Example 4, where the pre-drying temperature was increased to 60 °C, the bonding strength between the anode current collector and the first anode active material layer, the cohesion between the first anode active material layer and the second anode active material layer, and the cell cycle performance decreased, while the cell resistance increased, compared to Example 1.

In Example 5, where the pre-drying temperature was increased to 60 °C, the cohesion between the first anode active material layer and the second anode active material layer and the cell cycle performance were improved, while the cell resistance was reduced, compared to Example 2.

In Comparative Example 2, where different solvents were used but pre-drying was not performed, the bonding strength between the anode current collector and the first anode active material layer, the cohesion between the first anode active material layer and the second anode active material layer, and the cell cycle performance decreased, while the cell resistance increased.

1. A method for manufacturing an electrode for a secondary battery, comprising:
applying a first active material slurry to an electrode current collector to form a first coating layer;
pre-drying the first coating layer to form a first preliminary active material layer;
applying a second active material slurry to the first preliminary active material layer to form a second coating layer; and
converting the first preliminary active material layer and the second coating layer into a first active material layer and a second active material layer, respectively, through bulk drying performed at a temperature higher than the pre-drying temperature.

2. The method for manufacturing an electrode for a secondary battery according to claim 1, wherein the pre-drying comprises exposing the first coating layer to warm air at 40 to 60 °C.

3. The method for manufacturing an electrode for a secondary battery according to claim 2, wherein the pre-drying comprises exposing an upper surface of the first coating layer to warm air for 5 to 20 seconds per cm².

4. The method for manufacturing an electrode for a secondary battery according to claim 1, wherein the first active material slurry is supplied onto the electrode current collector through a first coating unit, and the second active material slurry is supplied onto the first preliminary active material layer through a second coating unit, and
wherein the second coating unit is spaced apart from the first coating unit along a coating direction.

5. The method for manufacturing an electrode for a secondary battery according to claim 4, wherein the pre-drying is performed through a first drying unit, the bulk drying is performed through a second drying unit, and
wherein the first drying unit is disposed between the first coating unit and the second coating unit along the coating direction.

6. The method for manufacturing an electrode for a secondary battery according to claim 5, wherein the second coating unit is disposed between the first drying unit and the second drying unit along the coating direction.

7. The method for manufacturing an electrode for a secondary battery according to claim 1, wherein the first active material slurry comprises a first active material and a first solvent, and the second active material slurry comprises a second solvent that is immiscible with the first solvent.

8. The method for manufacturing an electrode for a secondary battery according to claim 7, wherein the density of the first solvent is greater than the density of the second solvent.

9. The method for manufacturing an electrode for a secondary battery according to claim 7, wherein the first active material and the second active material are the same active material.

10. The method for manufacturing an electrode for a secondary battery according to claim 7, wherein the amount of the first active material included in the first active material layer is different from the amount of the second active material included in the second active material layer.

11. A method for manufacturing a secondary battery, comprising:
preparing the electrode for a secondary battery manufactured according to claim 1;
winding the electrode for a secondary battery to form an electrode assembly; and
accommodating the electrode assembly in a case.

12. The method for manufacturing a secondary battery according to claim 11, wherein the density of the active material layer disposed on the inner side in the winding direction of the electrode for a secondary battery is lower than the density of the active material layer disposed on the outer side.

13. The method for manufacturing a secondary battery according to claim 11, wherein the step of forming the electrode assembly comprises:
arranging the electrodes for a secondary battery on a first surface and a second surface opposite to each other of a separation membrane, respectively; and
winding the separation membrane together with the electrodes for a secondary battery.
